(19) United States
(12) Patent Application Publication
(10) Pub. No.: US 2007/0124527 A1
(43) Pub. Date: May 31, 2007

(54) Virtual Serial Apparatus

(75) Inventors: Hao Zhang, Beijing (CN); XiaoLin Zhu, Beijing (CN)

Correspondence Address: SILICON VALLEY PATENT AGENCY, 7394 WILDFLOWER WAY, CUPERTINO, CA, 95014, US

(73) Assignee: Vimicro Corporation

(21) Appl. No.: 11/382,044

(22) Filed: May 7, 2006

(30) Foreign Application Priority Data
Nov. 25, 2005 (CN) 200510115062.8

(51) Int. Cl. G06F 13/36

(52) U.S. Cl. 710/306

(57) ABSTRACT

Techniques for stably and rapidly communicating between a mobile communication device and a personal computer are disclosed. According to one aspect of the techniques, a virtual serial apparatus is provided between a baseband controller of a mobile communication device (MCD) and a transmission driver of a personal computer (PC). The virtual serial apparatus comprises a storage unit for buffering data to be transmitted, a baseband interface unit, a physical interface unit and a USB device controller. The baseband interface unit is provided between the baseband controller and the storage unit. The baseband controller accesses the storage unit via the baseband interface unit. The physical interface unit communicates with the transmission driver via a USB bus therebetween. The USB device controller is provided between the storage unit and the physical interface unit for processing and forwarding the data to be transmitted according to a USB protocol.

### BACKGROUND

1. Field of the Invention

The present invention generally relates to a virtual serial apparatus, and particularly to a virtual serial apparatus disposed between a mobile communication device (MCD) and a personal computer (PC).

2. Description of Related Art

Currently, communications between a mobile communication device (MCD), such as a mobile phone or a personal digital assistant (PDA), and a PC is achieved with infrared ports which are equipped on the MCD and the PC, respectively. However, the bandwidth of the infrared communication is seriously limited. Thus a universal serial bus (USB) interface is becoming a trend to be used in an MCD. Commonly known, the USB interface usually adopts a mass-storage transmission mode to carry out communications between a PC and a storage device, such as Secure Digital Memory Cards (SD cards), Nand flash memories.

Usually, the format of the data from an MCD is definable by a user. Hence, the data format in the MCD may be completely different from that in a storage device. Furthermore, the data communication with the MCD requires a stable bandwidth. Thus, the direct communication between the PC and the MDC can not yet be realized by an USB interface, so that many useful functions of the MDC may not be fully realized.

Thus there is a need for providing a virtual serial apparatus for stably and rapidly communication between a mobile communication device and a personal computer.

### SUMMARY OF THE INVENTION

This section is for the purpose of summarizing some aspects of the present invention and to briefly introduce some preferred embodiments. Simplifications or omissions in this section as well as in the abstract or the title of this description may be made to avoid obscuring the purpose of this section, the abstract and the title. Such simplifications or omissions are not intended to limit the scope of the present invention.

In general, the present invention pertains to techniques for providing a virtual serial apparatus for stably and rapidly communication between a mobile communication device and a personal computer.

One of the features, benefits and advantages in the present invention is to provide techniques for stably and rapidly communicating between a mobile communication device and a personal computer are disclosed. According to one aspect of the techniques, a virtual serial apparatus is provided between a baseband controller of a mobile communication device (MCD) and a transmission driver of a personal computer (PC). The virtual serial apparatus comprises a storage unit for buffering data to be transmitted, a baseband interface unit, a physical interface unit and a USB device controller. The baseband interface unit is provided between the baseband controller and the storage unit. The baseband controller accesses the storage unit via the baseband interface unit. The physical interface unit communicates with the transmission driver via a USB bus therebetween. The USB device controller is provided between the storage unit and the physical interface unit for processing and forwarding the data to be transmitted according to a USB protocol.

Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will become better understood with regard to the following description, appended claims, and accompanying drawings where:

FIG. 1 is a block diagram schematically showing a virtual serial apparatus of the present invention.

### DETAILED DESCRIPTION OF THE INVENTION

The detailed description of the present invention is presented largely in terms of procedures, steps, logic blocks, processing, or other symbolic representations that directly or indirectly resemble the operations of devices or systems contemplated in the present invention. These descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments.

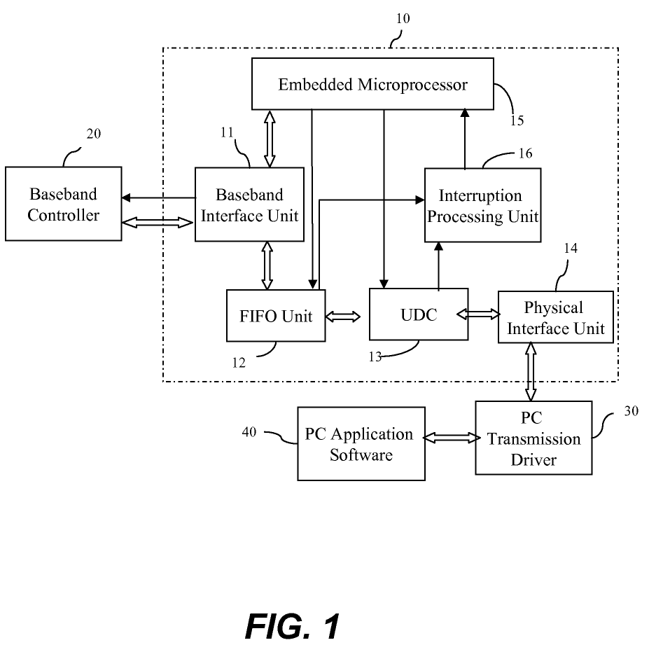

Referring to FIG. 1, there shows a block diagram of a virtual serial apparatus 10 in accordance with one embodiment of the present invention. The virtual serial apparatus 10 is coupled between a baseband controller 20 of a mobile communication device (MCD) and a transmission driver 30 of a personal computer (PC) and serves as a communication bridge. The baseband controller 20 manages data transmission between the virtual serial apparatus 10 and a baseband controller 20 of the MCD. Accordingly, the data exchange between the virtual serial apparatus 10 and the PC is controlled by the transmission driver 30 of the PC. According to one deployment, an application software module 40 running in the PC can call the transmission driver 30 for the data transmission. It should be noted that the baseband controller 20 and the transmission driver 30 can be implemented as software or hardware, or in a combination of both in the present invention.

The virtual serial apparatus 10 includes a baseband interface unit (BIU) 11, a first-in-first-out (FIFO) unit 12, a USB device controller (UDC) 13 and a physical interface unit (PIU) 14. The baseband controller 20 is provided to read/write data from/into the FIFO unit 12 via the BIU 11, thereby managing the data transmission between the FIFO unit 12 and the baseband controller 20. In one embodiment, the FIFO unit 12 is one or more buffers. Depending on implementation, the virtual serial apparatus 10 may be integrated in the MCD. It is further apparent to those skilled in the art that the virtual serial apparatus 10 can also be applied in other cases, such as communication between a personal digital assistant (PDA) and a PC.

In one embodiment, the BIU 11 is provided with an interrupt request mechanism for generating interrupt requests (IRQs) to the baseband controller 20. The BIU 11 includes a group of data-address duplicate bus and several groups of registers. The groups of registers include at least a group of null-bit registers for reporting null bits in the FIFO unit 12 in the data stream direction from the baseband controller 20 to the PC, a group of null-bit conditional registers and overtime conditional registers for providing interruption conditions. The groups of registers further include a group of volume registers for reporting a volume of data already stored in the FIFO unit 12 in the data stream direction from the PC to the baseband controller 20, and a group of volume conditional registers and overtime conditional registers for providing interruption conditions. The baseband controller 20 controls the interruption conditions by configuring the conditional registers in the BIU 11, thereby controlling the conditions to access the FIFO unit 12, such as the data volume condition, the null-bit condition etc. The FIFO unit 12 is mapped into one port in the BIU 11 by the data-address duplicate bus so that each storage unit of the FIFO has a fixed address in the mapped port. During data transmission, the BIU 11 serves as an address coder to switch the data-address duplicate bus according to the fixed address. Thus, the baseband controller 20 can access the FIFO unit 12 via the data address duplicate bus.

The UDC 13 between the FIFO unit 12 and the PIU 14 is provided for processing and forwarding data according to a USB protocol, including the CRC checkout, returning NAK automatically and etc. With the volume and null-bit reporting registers in the BIU 11, the UDC 13 is responsible for reporting the status of the FIFO unit 12 to the baseband controller 20. In one embodiment, according to various responses of various baseband controller 20, the UDC 13 is able to modify the value of the conditional registers in the BIU 11 in order to adjust the interruption condition and adjust the condition for accessing the FIFO unit 12, so that the data transmission process can be optimized.

The PIU 14 is provided for forwarding data to the transmission driver 30 via a USB bus disposed therebetween. The data exchange between them is subjected to the USB protocol. In one embodiment, the USB 2.0 protocol is employed in the USB bus. It is well known to ordinary skilled person in the art that although the bandwidth will be adversely affected due to the transmitting capacity of the USB 1.1 protocol, the virtual serial apparatus of the present invention is compatible with the USB 1.1 protocol.

In order to realize the virtual serial function, a USB interruption transmission mode is particularly introduced in the virtual serial apparatus 10, such as USB2.0 interruption transmission mode. The USB interruption transmission mode has several advantages than other USB transmission modes do. Specifically, the USB interruption transmission mode has a larger bandwidth than the USB control transmission mode, has an error retransmit mechanism that the equal time transmission mode does not have, and has a bandwidth stability that the batch transmission mode does not have. In one embodiment, the virtual serial apparatus 10 can also adopt other USB transmission mode to realize the virtual serial function.

Referring back to FIG. 1, the virtual serial apparatus 10 also includes an embedded microprocessor 15 and an interruption processing unit 16. The embedded microprocessor 15 is provided for initializing and controlling the UDC 13. An operation of the embedded microprocessor is specifically described as following: identifying if the USB bus is powered, if YES, the embedded microprocessor notifies the baseband controller 20 via the BIU 11; responding starting information to the embedded microprocessor 15 via the BIU 11 for starting the USB transmission; configuring parameters of the UDC 13, such as the bandwidth, according to the received starting information by the embedded microprocessor 15; subsequently, starting the USB transmission. At the same time, the embedded microprocessor 15 also controls the behavior of the UDC 13 as well as enumerating process.

The interruption processing unit 16 is provided for arbitrating interruption requests from the FIFO unit 12 and the UDC 13 and sending the arbitrated interruption requests to the embedded microprocessor 15. During the data transmission process, the baseband controller 20 can configure the interruption generation condition of the UDC 13 and the FIFO unit 12 so that the data transmission can adapt to various requirements of the users.

In order to better understand the virtual serial apparatus 10, the data transmission between the MCD and the PC is further described. When the PC has data required to be transmitted to the baseband of the MCD, the transmission driver 30 is called for transmitting the pending data to the PIU 14 via the USB bus. The PIU 14 receives the transmitted data and forwards it to the UDC 13. The UDC 13 processes the received data according to the USB2.0 protocol, and then forwards the processed data to the FIFO unit 12. When the data volume stored in the FIFO unit 12 or the time meets the condition in the conditional registers of the BIU 11, for an instance, the data volume exceeds a threshold which is determined by the volume conditional register, the BIU 11 generates an IRQ to notify the baseband controller 20. Then, the baseband controller 20 is interrupted to obtain the stored status accordingly to scan the volume registers and then read the data from the FIFO unit 12 via the BIU 11.

When the baseband controller 20 of the MCD has data required to be transmitted to the PC, the baseband controller 20 firstly inquires how many null-bits are there in the FIFO unit 12 by scanning the null-bit registers in the BIU 11. If the null-bits meet the null-bit condition in the conditional register, the baseband controller 20 is interrupted to write the pending data into the FIFO unit 12 via the BIU 11. When the data volume stored in the FIFO unit 12 or the time meets with the conditions in the conditional registers, the pending data stored in the FIFO unit 12 is forwarded to the UDC 13 which processes the received data according to the USB2.0 protocol and sends the processed data to the PIU 14 via USB bus in the USB interruption transmission mode. Finally, the transmission driver 30 receives the transmitted data from the USB bus.

During the data transmission process, if the embedded microprocessor 15 is needed, the FIFO unit 12 or the UDC 13 will notify the embedded microprocessor 15 via the interruption processing unit 16.

While the present invention has been described with reference to specific embodiments, the description is illustrative of the invention and is not to be construed as limiting the invention. Various modifications to the present invention can be made to the preferred embodiments by those skilled in the art without departing from the true spirit and scope of the invention as defined by the appended claims.

What is claimed is:

1. A virtual serial apparatus, provided between a baseband controller of a mobile communication device (MCD) and a transmission driver of a personal computer (PC), the apparatus comprising:
a storage unit for buffering data to be transmitted;
a baseband interface unit provided between the baseband controller and the storage unit, the baseband controller accessing the storage unit via the baseband interface unit;
a physical interface unit for communicating with the transmission driver via a USB bus therebetween;
a USB device controller provided between the storage unit and the physical interface unit for processing and forwarding the data to be transmitted according to a USB protocol.

2. The virtual serial apparatus as claimed in claim 1, wherein the baseband interface unit has at least a data-address duplicate bus by which the baseband controller accesses the storage unit.

3. The virtual serial apparatus as claimed in claim 1, wherein the baseband interface unit has a group of registers for reporting a status of the storage unit.

4. The virtual serial apparatus as claimed in claim 1, wherein the baseband interface unit has a group of conditional registers for providing interruption conditions according to which interrupt requests are generated to the baseband controller.

5. The virtual serial apparatus as claimed in claim 4, wherein the group of conditional registers is configurable by the baseband controller.

6. The virtual serial apparatus as claimed in claim 4, wherein the group of conditional registers is configurable by the USB device controller.

7. The virtual serial apparatus as claimed in claim 1, wherein the storage unit is a first-in-first-out unit.

8. The virtual serial apparatus as claimed in claim 1, wherein the USB protocol is USB 2.0 protocol.

9. The virtual serial apparatus as claimed in claim 1, wherein the virtual serial apparatus is introduced in a USB interruption transmission mode.

10. The virtual serial apparatus as claimed in claim 1, further comprising an embedded microprocessor for initializing and controlling the USB device controller.

11. The virtual serial apparatus as claimed in claim 1, further comprising an interruption processing unit for arbitrating interruption requests from the storage unit and the USB device controller and sending the arbitrated interruption requests to the embedded microprocessor.

12. A mobile communication device comprising:
a baseband controller;
a virtual serial apparatus provided between the baseband controller and a transmission driver of a personal computer (PC), the virtual serial apparatus comprising:
a storage unit for buffering data to be transmitted;
a baseband interface unit provided between the baseband controller and the storage unit, the baseband controller accessing the storage unit via the baseband interface unit;
a physical interface unit for communicating with the transmission driver via a USB bus therebetween;
a USB device controller provided between the storage unit and the physical interface unit for processing and forwarding the data to be transmitted according to a USB protocol.

13. The virtual serial apparatus as claimed in claim 12, wherein the baseband interface unit has at least a data-address duplicate bus by which the baseband controller accesses the storage unit.

14. The virtual serial apparatus as claimed in claim 12, wherein the baseband interface unit has a group of registers for reporting a using status of the storage unit.

15. The virtual serial apparatus as claimed in claim 14, wherein the baseband interface unit has a group of conditional registers for providing interruption conditions by which interrupt requests are generated to the baseband controller.

16. The virtual serial apparatus as claimed in claim 14, wherein the group of conditional registers is configurable by the baseband controller.

17. The virtual serial apparatus as claimed in claim 14, wherein the group of conditional registers is configurable by the USB device controller.
